(19) United States
(12) Patent Application Publication
(10) Pub. No.: US 2015/0108318 A1
(43) Pub. Date: Apr. 23, 2015

(54) Post Support Stand

(71) Applicant: Charles Orr, Oak Park, IL (US)

(72) Inventor: Charles Orr, Oak Park, IL (US)

(21) Appl. No.: 14/493,588

(22) Filed: Sep. 23, 2014

Related U.S. Application Data
(60) Provisional application No. 61/894,178, filed on Oct. 22, 2013.

(51) Int. Cl. E04H 17/26; E04H 12/22; F16M 11/32

(52) U.S. Cl. CPC E04H 17/263; F16M 11/32; E04H 12/2238
USPC 248/523

(57) ABSTRACT

Described is a post support stand that can be used to temporarily support a fence post or similar object in a vertical, upright orientation during installation. The support stand includes a bracket having a central opening in which a post can be positioned. A plurality of clamps is disposed on the bracket and can be adjusted so that the clamps engage the post. The bracket may include a pivoting gate thereon to facilitate insertion of a post into the central opening of the bracket. A plurality of legs extends downward and outward from the bracket at an angle so as to provide a wide and stable base. The legs are preferably telescopic so that they can be adjusted in length, and the legs are connected to one another by crossbars. Once a post is secured within the ground, the support stand can be removed therefrom.

### CROSS REFERENCE TO RELATED APPLICATION

This application claims the benefit of U.S. Provisional Application No. 61/894,178 filed on Oct. 22, 2013, entitled “Korr's Adjustable Pole Setter.” The above identified patent application is herein incorporated by reference in its entirety to provide continuity of disclosure.

### BACKGROUND OF THE INVENTION

1. Field of the Invention

The present invention relates to a post support stand. More specifically, the present invention provides a support stand adapted to hold a post in an upright, vertical position during installation and that can be removed once the post has been secured within the ground. The support stand includes a bracket having a central opening in which a post can be positioned, one or more clamps for securing the post therein, and a plurality of legs that extend downward and outward therefrom so as to stabilize the post during installation.

When installing a fence, it is necessary to secure fence posts within the ground. This is often performed by digging a hole in which a lower portion of the fence post can be placed, positioning the fence post in a vertical, upright orientation, and then filling the hole with concrete or a similar filler material so as to permanently affix the fence post in the desired position. This process must be repeated several times, as fence posts must be inserted in the ground at a fixed interval along the length of the fence.

In order to properly position the fence post and pour cement, it is generally necessary for one or more people to hold the fence post and one or more people to pour the cement. If a user attempts to hold a fence post while pouring cement, the fence post may lean or tilt, causing the fence post to be secured within the cement at an angle. If a fence post is installed at an angle, the fence post may have to be removed and repositioned. Thus, installing fence posts can be difficult and time consuming, particularly when a user is attempting to install the fence posts by himself or herself.

The present invention provides a post support stand. The device comprises a bracket having a central opening. The bracket includes a plurality of clamps for holding a post in a vertical, upright position within the bracket. The bracket may include a pivoting gate thereon for facilitating insertion of the post into the opening of the bracket. A plurality of legs extends downward from the bracket, and extends outward from the bracket at an angle, so as to provide a wide base. The legs are preferably telescopic so that they can be extended or shortened in length as desired. Thus, the present invention can be used to securely hold a post in a desired position during installation, and can be easily removed therefrom once the post is installed.

2. Description of the Prior Art

Devices have been disclosed in the prior art that relate to column or post support devices. These include devices that have been patented and published in patent application publications. These devices generally relate to support stands for stabilizing a post or securing a post within the ground. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 6,684,580 to Hull discloses a post stabilization support. The device comprises a post receiving sleeve having legs thereon. Locking cam levers are used to secure the sleeve to a post. Each leg can be adjusted independently and includes a foot for engaging the ground. Leveling devices are included on the sleeve to facilitate vertical positioning of a post therein. Thus, while Hull discloses a post stabilization device, the device does not include adjustable clamps for engaging a post, and does not include a gate thereon that facilitates insertion and removal of a post from the sleeve or bracket of the device.

U.S. Pat. No. 8,322,106 to Simmons discloses a column stabilizing device. The device comprises a stand for stabilizing a column and includes an upper and lower clamping collar, wherein the collars can be used to grip the base of a column at spaced locations along the base of the column. The device further includes ground engaging outrigger legs joined to the collars for supporting the column. Thus, Simmons discloses a column stabilizing device and does not disclose a device comprising a bracket having adjustable clamps thereon, and further having a plurality of telescopic legs secured thereto.

U.S. Pat. No. 7,137,608 to Willey discloses a support stand. The support stand comprises a first, second, and third leg assembly pivotally secured to an upper support member. The upper support member includes an aperture for accepting a portion of an article therein. A lower end of each leg assembly is pivotally secured to a lower support member. Each leg assembly comprises a hinge-fitting interconnecting elongated subassemblies, wherein the subassemblies include telescopic sections. Thus, Willey discloses a support stand, but does not disclose a support stand comprising a bracket in which a post can be positioned, and having adjustable clamps thereon for securing the post within the bracket.

U.S. Pat. No. 7,182,303 to Speggiorin discloses a tripod stabilizing device. The device comprises a rod for each leg of the tripod, wherein the rods are connected at one end and are attached to a tripod leg at the other end. Each rod is telescopic and includes a locking member for holding the rod in a desired position. Thus, Speggiorin disclose a device for stabilizing a tripod, and fails to disclose a support device adapted to hold a post or similar object.

Finally, U.S. Pat. No. 3,809,346 to Jackson discloses a fence post support. The fence post support comprises a fence post receiving socket and a base plate. Drift pins are disposed through brackets on the socket and base plate and extend into the ground at a forty-five degree angle. The drift pins help to anchor the fence post support to the ground. Thus, Jackson discloses a fence post support comprising a socket in which a fence post can be positioned, and fails to disclose a removable support for stabilizing a fence post comprising a bracket and a plurality of legs extending downward therefrom.

These prior art devices have several known drawbacks. The devices in the prior art include stabilizing support stands, but do not include a bracket having adjustable clamps for securing a post therein. The clamps can be used to secure posts of various sizes and cross sections, and help to maintain the post in the desired position. Further, many devices fail to disclose a plurality of telescopic legs that extend outward from the post supporting structure. The legs extend outward to provide a wide base for supporting the post, and extend outward and away from a hole in which a fence post is to be positioned.

In light of the devices disclosed in the prior art, it is submitted that the present invention substantially diverges in design elements from the prior art and consequently it is clear that there is a need in the art for an improvement to existing post support devices. In this regard the instant invention substantially fulfills these needs.

### SUMMARY OF THE INVENTION

In view of the foregoing disadvantages inherent in the known types of post support devices now present in the prior art, the present invention provides a new post support stand wherein the same can be utilized for providing convenience for the user when installing fence posts or similar objects.

It is therefore an object of the present invention to provide a new and improved post support stand that has all of the advantages of the prior art and none of the disadvantages.

It is another object of the present invention to provide a post support stand adapted to hold a post or a similar structure in a vertical, upright orientation.

Another object of the present invention is to provide a post support stand that includes adjustable legs for disposing a post supporting bracket at a desired height.

Yet another object of the present invention is to provide a post support stand that includes adjustable clamps for adjustably securing posts of different sizes.

A further object is to provide a post support stand comprising a pivoting gate disposed on a post supporting bracket for facilitating insertion of a post into said bracket.

Another object of the present invention is to provide a post support stand that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the post support stand of the present invention.

FIG. 2 shows a perspective view of the post support stand having a post secured therein.

FIG. 3 shows a top down view of the post support stand as positioned about a fence post.

### DETAILED DESCRIPTION OF THE INVENTION

Reference is made herein to the attached drawings. Like reference numerals are used throughout the drawings to depict like or similar elements of the post support device. For the purposes of presenting a brief and clear description of the present invention, the preferred embodiment will be discussed as used for supporting a post in a vertical, upright orientation. The figures are intended for representative purposes only and should not be considered to be limiting in any respect.

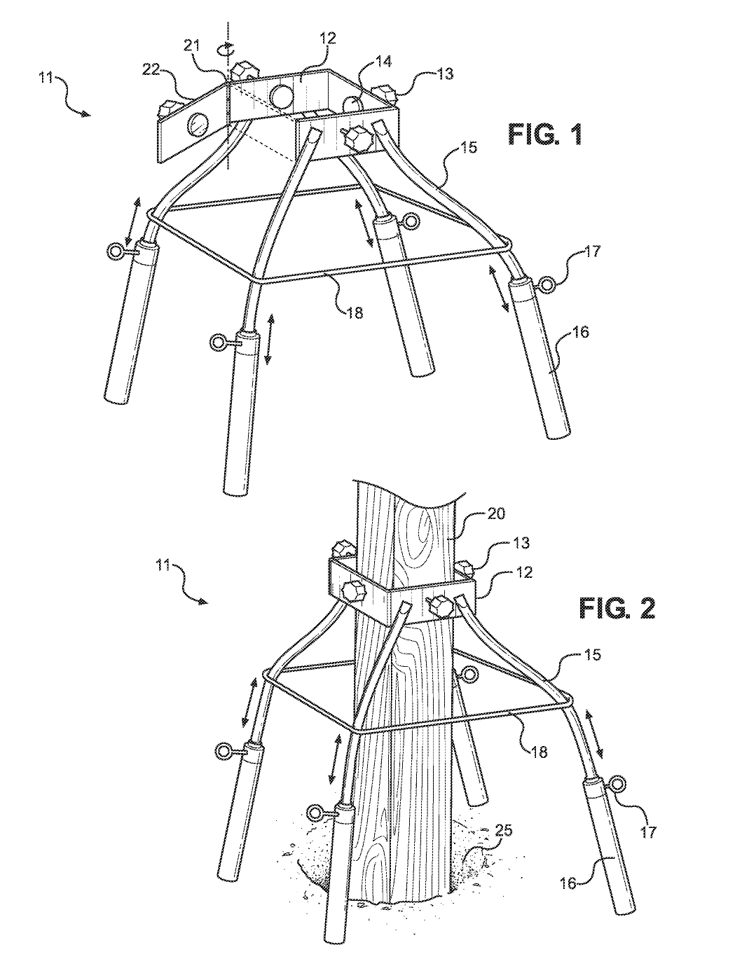

FIG. 1 shows a perspective view of the post support stand of the present invention. The post support stand 11 of the present invention includes a bracket 12 having a central opening in which a post, such as a fence post, a support post, a pole, or a column, and the like, can be positioned. Posts of various sizes and cross sections can be positioned therein. The bracket 12 is preferably substantially square and includes four walls, defining the central opening. The walls are preferably rectangular in shape. One wall of the bracket 12 may comprise a gate 22 thereon that pivots about a hinge 21. In this way, the central opening of the bracket 12 can be accessed by opening the gate 22. The gate 22 can be opened to facilitate insertion of a post within the central opening of the bracket 12, and can then be rotated into a closed position so as to constrain the post to the central opening of the bracket 12. The gate 22 includes a latch on an end thereof for securing the gate 22 in a closed position so as to prevent the gate 22 from swinging open unintentionally.

The bracket 12 includes one or more clamps thereon. Preferably, each wall of the bracket 12 comprises a clamp thereon, and the clamp may be centrally located on each wall of the bracket 12. The clamps comprise a threaded shaft having a first end and a second end, wherein a knob 13 is positioned on the first end, and a plate 14 is positioned on the second end. Each wall of the bracket 12 includes a threaded aperture through which the threaded shaft of each clamp is inserted. The clamp is positioned such that the knob 13 is on the exterior of the bracket 12, and the plate 14 is positioned within the central opening of the bracket 12. By turning or twisting the knob 13, the plate 14 on the end of the shaft is moved farther into the interior of the central opening, or is retracted towards the wall of the bracket 12, depending upon the direction in which the knob 13 is turned. In this way, a user can adjust the positioning of the plate 14 so that the plate 14 engages a post positioned within the central opening.

A plurality of legs extend downward from the bracket 12 and support the bracket 12 in an elevated position above the ground. The legs are preferably tubular and may include an arcuate shape. The legs can be extended or shortened in length as desired in order to position the bracket 12 at a desired height. Preferably, the legs are telescopic and include an upper section 15 and a lower section 16. The upper section 15 is slidably inserted into the lower section 16 and can be extended therefrom or retracted into the lower section 16 as desired. In this way, each leg can be independently adjusted to a desired length, and secured in place by means of a fastener 17 on each leg 15. The fastener 17 may include a hand screw that can be adjusted so as to hold the upper section 15 in a desired position relative to the lower section 16.

The legs 15 preferably extend outward from the bracket 12 at an angle, so as to provide a wide and stable base. In the illustrated embodiment, four legs are secured to the bracket 12, wherein each leg is positioned near a corner of the bracket 12, forming a substantially square configuration. The legs may be secured to one another by means of one or more crossbars 18 that serve to stabilize the legs. In some embodiments, each crossbar 18 is substantially linear and connects a pair of legs to one another. In an alternate embodiment, one crossbar 18 having a square configuration is provided that engages each leg of the post support device 11. The crossbar or crossbars 18 are disposed in a horizontal orientation and are preferably positioned on the upper section 15 of the legs.

FIG. 2 shows a perspective view of the post support stand having a post secured therein. A post 20 can be positioned within the bracket 12 so that is it constrained thereby. The post 20 is positioned in a vertical orientation such that the lower end is positioned on the ground in a desired location, or within a hole 25 in the ground. Once the post 20 is positioned within the bracket 12, the clamps can be manually adjusted by turning the knobs 13 thereon until each plate engages a side of the post 20, so as to secure the post 20 in a desired orientation. Thus, the present invention fully supports and secures the post 20 so that a user does not need to hold the post while installing the post into the ground.

The legs of the support stand 11 extend outward from the bracket 12 so as to provide a wide and stable base, preventing the post 20 from tipping over. Further, the relatively wide positioning of the legs allows the device to be placed over a hole 25 in which the post 20 is inserted. In operation, the upper section 15 of the legs is preferably extended outward from the lower section 16 of the legs so that the bracket 12 is disposed on a mid-portion of the post 20. By disposing the bracket 20 on a mid-portion of the post 20, the post 20 can be better stabilized and prevented from tipping over. Once the upper section 15 of the legs is extended as desired, the legs can be secured in a desired position by adjusting the fasteners 17 on the lower section 16 of the legs.

Once the post 20 is inserted within a hole 25, the hole 25 can be filled with cement or another filler material so that the post 20 will permanently remain in the desired configuration once the present invention is removed therefrom. Thus, a user can easily install fence posts or other support posts in a desired orientation without the need for assistance from other people.

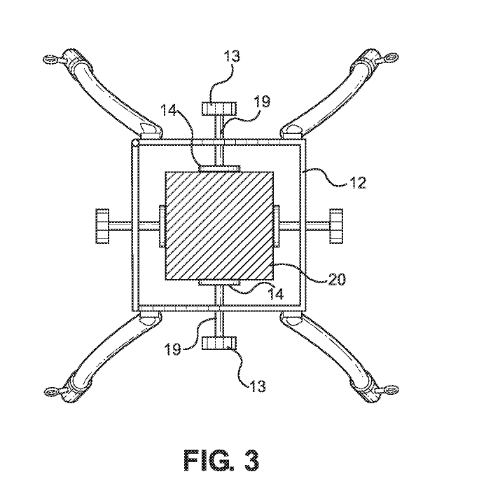

FIG. 3 shows a top down view of the fence post support device as positioned about a fence post. A fence post 20 is positioned in the opening of the bracket 12. In this way, the fence post 20 is constrained by the bracket 12. Each wall of the bracket 12 includes an aperture therethrough. Preferably, the aperture is roughly centrally located on each wall. The shaft 19 of each clamp is inserted through an aperture such that a first end of the shaft 19 is outside of the bracket 12, and a second end is inside of the bracket 12. Further, clamps on opposing walls of the bracket are aligned on a horizontal axis. The first end of each shaft 19 includes a knob 13 thereon that can be easily grasped by a user. The second end of the shaft 19 includes a plate 14 thereon that is adapted to be placed flush against the exterior of a post 20. The shaft 19 of the clamp is preferably threaded, and the aperture on the wall is threaded. Thus, by turning or twisting the knob 13, the plate 14 is moved closer to or farther from the post 20 within the bracket 12. The clamps can be individually adjusted so that each plate 14 is placed flush against a side of the post 20 so as to secure the fence post 20 in a desired orientation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A post support device, comprising:
a bracket defining a central opening adapted to receive a portion of a post therethrough;
one or more clamps adjustably secured to said bracket adapted to secure said post within said central opening of said bracket;
a plurality of legs attached to said bracket and extending downward therefrom.

2) The post support device of claim 1, wherein said bracket comprises a substantially square shape.

3) The post support device of claim 1, wherein said bracket comprises a gate pivotally attached thereto by means of a hinge.

4) The post support device of claim 1, wherein said one or more clamps include a shaft having a first end and second end, wherein said first end includes a knob thereon, and wherein said second end includes a plate adapted to be positioned against said post.

5) The post support device of claim 4, wherein said first end of said shaft is disposed within said central opening of said bracket and said second end of said shaft is outside of said central opening of said bracket.

6) The post support device of claim 1, wherein said plurality of legs are connected to one another by one or more crossbars.

7) The post support device of claim 1, wherein said plurality of legs is telescopic and includes an upper section slidably inserted into a lower section such that said plurality of legs can be extended or shortened.

8) The post support device of claim 7, wherein said plurality of legs further includes fasteners thereon for securing said plurality of legs in a desired position.

9) The post support device of claim 1, wherein said plurality of legs extends downward and outward from said bracket.

10) The post support device of claim 1, wherein said plurality of legs includes four legs arranged in a substantially square configuration.

11) The post support device of claim 1, wherein said bracket comprises four walls;
wherein said one or more clamps are centrally located on each of said four walls of said bracket.
